(19) United States
(12) Patent Application Publication
(10) Pub. No.: US 2026/0053164 A1
(43) Pub. Date: Feb. 26, 2026

(54) COMPACT COLD DRINK DISPENSER

(71) Applicant: Guangdong Welly Electrical Appliances Co., Ltd., Zhongshan (CN)

(72) Inventors: Xiangan Wu, Zhongshan (CN); Quan Zhou, Zhongshan (CN)

(21) Appl. No.: 19/017,821

(22) Filed: Jan. 13, 2025

(30) Foreign Application Priority Data
Aug. 20, 2024 (CN) 202422023825.7

(51) Int. Cl. A23G 9/04; A23G 9/12; A23G 9/22

(52) U.S. Cl. CPC A23G 9/045; A23G 9/12; A23G 9/222

(57) ABSTRACT

This application discloses a compact cold drink dispenser comprising a casing, a bracket, a freezing cylinder, a compressor, a heat exchanger, a mixer, a drive motor, and a control panel. The casing is provided with an accommodation cavity, and the bracket is disposed within the accommodation cavity, dividing the accommodation cavity into a mixing and preparation layer and a heat exchange and refrigeration layer. The compact cold drink dispenser utilizes the bracket to divide the accommodation cavity into two layers: the mixing and preparation layer on top and the heat exchange and refrigeration layer below. The freezing cylinder, compressor, heat exchanger, mixer, drive motor, and control panel are respectively disposed on the mixing and preparation layer and the heat exchange and refrigeration layer, making the assembly of various components within the casing compact and eliminating the need for excessive internal space.

### CROSS REFERENCE TO RELATED APPLICATIONS

The present application claims the benefit of Chinese Patent Application No. 202422023825.7 filed on Aug. 20, 2024, the contents of which are incorporated herein by reference in their entirety.

### TECHNICAL FIELD

This application relates to the field of an ice cream manufacturing device, particularly to a compact cold drink dispenser.

### BACKGROUND

Existing cold drink dispensers comprise components such as a freezing cylinder, compressor, heat exchanger, mixer, and drive motor. The heat exchanger, which is used for dissipating heat from the compressor, requires space for installing the condenser and for exhaust ventilation due to heat dissipation needs. Furthermore, the compressor, freezing cylinder, and drive motor have relatively large structures, and the various structural parts cannot be positioned too close to each other to prevent the heat generated during operation from lowering the temperature of the freezing cylinder, which would cause the temperature inside the freezing cylinder to fail to reach the required level. Therefore, the width or length of the cold drink dispenser's body is relatively large to reserve sufficient space, resulting in an overall large size for the cold drink dispenser and occupying a large area on the countertop. This makes it inconvenient for application in smaller spaces such as home kitchens.

### SUMMARY

The purpose of this application is to propose a compact cold drink dispenser that solves the problem of existing cold drink dispensers having a large overall size and occupying a large countertop area.

To achieve this purpose, the following technical solution is adopted in this application.

This application provides a compact cold drink dispenser, comprising a casing, a support frame, a freezing cylinder, a compressor, a heat exchanger, a mixer, a drive motor, and a control panel.

The casing is provided with an accommodation chamber, and the support frame is disposed within the accommodation chamber, dividing the accommodation chamber into a mixing and preparation layer and a heat exchange and refrigeration layer. The mixer is installed inside the freezing cylinder and is rotated by the drive motor. The freezing cylinder, drive motor, and control panel are disposed in the mixing and preparation layer. The compressor and heat exchanger are detachably connected to the heat exchange and refrigeration layer. The control panel is electrically connected to the drive motor and compressor.

The compressor and heat exchanger are connected through a heat exchange circulation pipeline, and the compressor is provided with a refrigeration circulation pipeline. The refrigeration circulation pipeline passes through the support frame and is wound around the periphery of the freezing cylinder. One end of the refrigeration circulation pipeline is connected to the cold source output end of the compressor, and the other end of the refrigeration circulation pipeline is connected to the heat source input end of the compressor.

In the compact cold drink dispenser, the support frame comprises a front support bracket, a horizontal plate, a first support plate, and a second support plate.

The upper end of the front support bracket is detachably connected to the front end of the horizontal plate, and the lower end of the front support bracket is detachably connected to the bottom of the accommodation chamber. The upper end of the first support plate is detachably connected to the rear end of the horizontal plate, and the lower end of the first support plate is detachably connected to the bottom of the accommodation chamber. The lower end of the second support plate is connected to the top surface of the horizontal plate, and the upper end of the second support plate is detachably connected to the top of the accommodation chamber. The first support plate and the casing form a first accommodation cavity, where the heat exchanger is disposed. The second support plate and the casing form a second accommodation cavity, where the control panel is disposed.

In the compact cold drink dispenser, the horizontal plate is downwardly recessed to form an installation recess, and the bottom of the installation recess is provided with an inclined surface that tilts towards one side in the length direction of the casing. The fixed end of the drive motor abuts against the inclined surface, causing the drive motor to tilt towards one side in the length direction of the casing.

In the compact cold drink dispenser, the heat exchanger is vertically installed in the first accommodation cavity, and the first support plate is provided with a through hole, with a fan disposed on the side of the through hole close to the compressor.

In the compact cold drink dispenser, the rear side wall of the casing is provided with a first heat dissipation louvered window and a second heat dissipation louvered window. The position of the first heat dissipation louvered window is compatible with the position of the first accommodation cavity, and the position of the second heat dissipation louvered window is compatible with the position of the second accommodation cavity.

In the compact cold drink dispenser, multiple heat dissipation holes are spaced apart on both the left and right sides of the casing.

In the compact cold drink dispenser, a raw material inlet is provided on the top surface of the casing, which is connected to the feed end of the freezing cylinder. An ice cream outlet is provided on the front side wall of the casing, which is connected to the discharge end of the freezing cylinder.

In the compact cold drink dispenser, the compressor is vertically installed, making the cylinder centerline of the compressor perpendicular to the bottom of the casing.

In the compact cold drink dispenser, a concave cavity and an ice cream holder are provided on the left side wall and/or right side wall of the casing. One end of the ice cream holder is hinged to the concave cavity, and the size and shape of the concave cavity are compatible with the ice cream holder.

In the compact cold drink dispenser, the control panel and/or the heat exchanger are located at the edge of the support frame and closely adjacent to the casing.

In the compact cold drink dispenser, the cold drink dispenser is an ice cream machine or a slushie machine.

One of the technical solutions in this application can have the following beneficial effects.

The compact cold drink dispenser utilizes a support frame to divide the accommodation chamber into an upper mixing and preparation layer and a lower heat exchange and refrigeration layer. The freezing cylinder, compressor, heat exchanger, mixer, drive motor, and control panel are respectively disposed on the mixing and preparation layer and the heat exchange and refrigeration layer, enabling compact assembly of the various components within the casing without the need to reserve excessive internal space. While ensuring that the temperature of the freezing cylinder is not affected by other components, the volume of the casing is reduced, thereby reducing the overall dimensions of the cold drink dispenser and minimizing the countertop area occupied. This allows the cold drink dispenser to be suitable for smaller spaces such as home kitchens.

### BRIEF DESCRIPTION OF DRAWINGS

FIG. 1 is a structural diagram of one embodiment of the present application;

FIG. 2 is a structural diagram of the other side of the embodiment shown in FIG. 1;

FIG. 3 is a schematic diagram of the connection between the support and the casing in one embodiment of the present application;

FIG. 4 is an internal structural diagram of one embodiment of the present application;

FIG. 5 is a schematic diagram showing the positions of various parts in one embodiment of the present application.

### REFERENCE NUMERALS

Casing 1; Support 2; Freezing Cylinder 3; Compressor 4; Heat Exchanger 5, Drive Motor 6; Control Panel 7;

Accommodation Chamber 10; First Louvered Ventilation Window 11, Second Louvered Ventilation Window 12; Heat Dissipation Holes 13; Raw Material Inlet 14; Ice Cream Outlet 15; Concave Cavity 16, Ice Cream Holder 17; Front Support Frame 21, Horizontal Plate 22, First Support Plate 23, Second Support Plate 24; Fixed Housing 31;

Installation Concave Cavity 220; Fan 231.

### DESCRIPTION OF EMBODIMENTS

The following provides a detailed description of the embodiments of the present application, with examples of the embodiments illustrated in the accompanying drawings. Identical or similar labels throughout represent identical or similar components or components with identical or similar functions. The embodiments described below with reference to the accompanying drawings are exemplary and solely intended for explaining the present application, and should not be construed as limiting its scope.

In the description of the present application, it should be understood that terms such as “longitudinal,” “lateral,” “upper,” “lower,” “front,” “rear,” “left,” “right,” “vertical,” “horizontal,” “top,” “bottom,” “inner,” “outer,” and other indicators of orientation or positional relationships are based on the orientation or positional relationships shown in the accompanying drawings. These terms are solely for the purpose of facilitating the description and simplifying it, and do not indicate or imply that the devices or components referred to must have specific orientations, be constructed and operated in specific orientations. Therefore, they should not be construed as limiting the present application. Additionally, features qualified by “first” and “second” may explicitly or implicitly comprise one or more of such features, used solely for distinguishing described features without implication of sequence or importance.

In the description of the present application, unless otherwise specified, the term “multiple” refers to two or more.

In the description of the present application, it should be noted that, unless otherwise explicitly defined and limited, terms such as “installed,” “connected,” and “linked” should be broadly interpreted. For example, they can refer to fixed connections, detachable connections, or integral connections; mechanical connections or electrical connections; direct connections or indirect connections through intermediary media; or internal connectivity between two components. For ordinary skilled persons in the art, the specific meanings of these terms in the context of the present application can be understood based on specific circumstances.

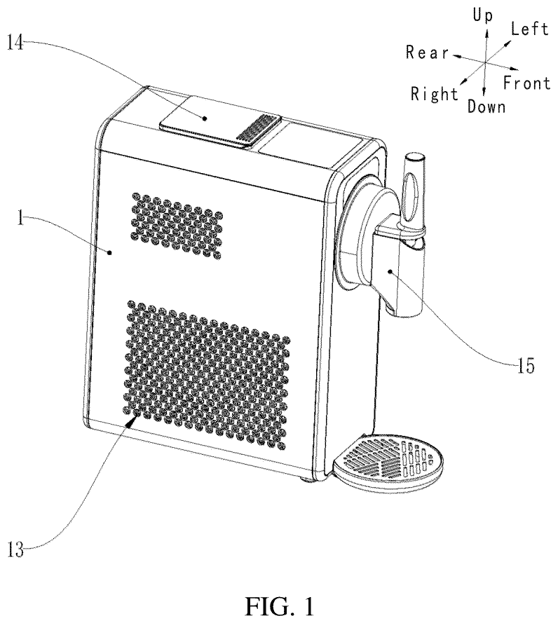

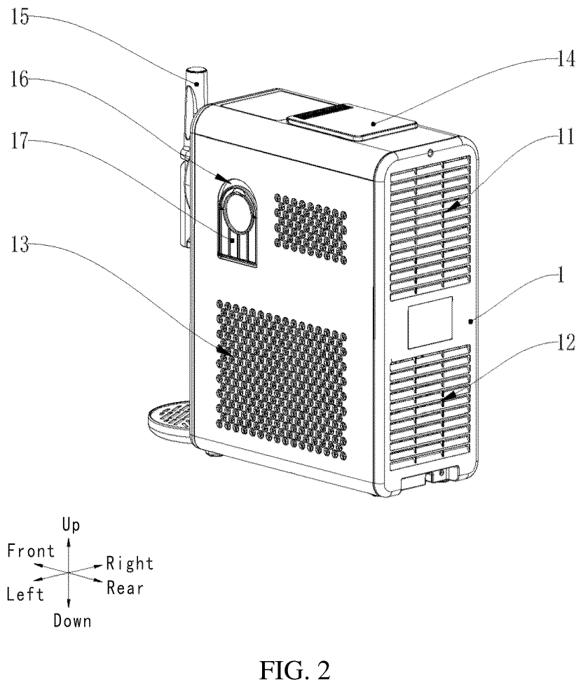

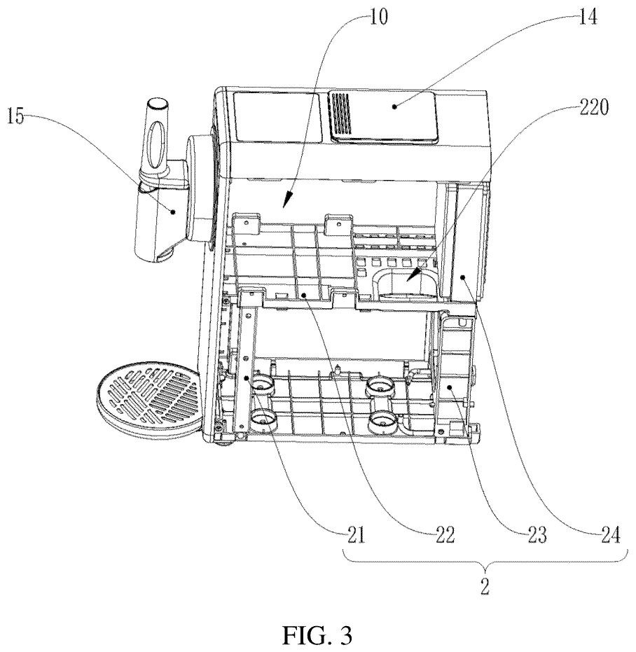

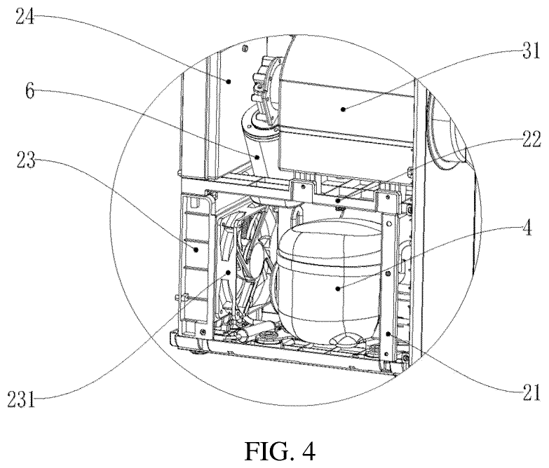

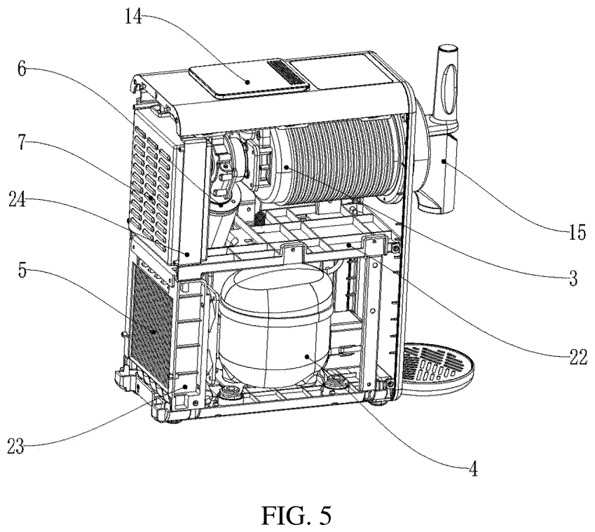

Please refer to FIGS. 1 to 5. The present application provides a compact cold drink dispenser, which comprises a casing1, a stand 2, a freezing cylinder 3, a compressor 4, a heat exchanger 5, a mixer, a drive motor 6, and a control panel 7.

The casing1 is equipped with an accommodating chamber 10, and the stand 2 is set within the accommodating chamber 10, dividing the accommodating chamber 10 into a mixing and preparation layer and a heat exchange and refrigeration layer. The mixer is installed inside the freezing cylinder 3, and the drive motor 6 drives the mixer to rotate. The freezing cylinder 3, drive motor 6, and control panel 7 are arranged in the mixing and preparation layer. The compressor 4 and heat exchanger 5 are detachably connected to the heat exchange and refrigeration layer. The control panel 7 is electrically connected to both the drive motor 6 and the compressor 4.

The compressor 4 and heat exchanger 5 are connected through a heat exchange circulation pipeline, and the compressor 4 is equipped with a refrigeration circulation pipeline. The refrigeration circulation pipeline passes through the stand 2 and is wound around the outer periphery of the freezing cylinder 3. One end of the refrigeration circulation pipeline is connected to the cold source output end of the compressor 4, while the other end is connected to the heat source input end of the compressor 4.

The compact cold drink dispenser utilizes the stand 2 to divide the accommodating chamber 10 into the mixing and preparation layer and the heat exchange and refrigeration layer, arranged vertically. The freezing cylinder 3, compressor 4, heat exchanger 5, mixer, drive motor 6, and control panel 7 are respectively placed on the mixing and preparation layer and the heat exchange and refrigeration layer, making the components within the casing1 compactly assembled without the need for excessive internal space. While ensuring that the temperature of the freezing cylinder is not affected by other components, the volume of the casing 1 is reduced, thereby reducing the overall dimensions of the cold drink dispenser. This results in less occupied countertop space, making it suitable for smaller places such as home kitchens.

The working principles of the freezing cylinder 3, compressor 4, and heat exchanger 5 can be referenced from existing cold drink dispensers. Through the operation of the compressor 4 and heat exchanger 5, the refrigerant absorbs heat and transforms from a liquid to a gas. The refrigerant gas then undergoes heat exchange with the outer wall of the freezing cylinder 3 through the refrigeration circulation pipeline, which incorporates an expansion valve within the heat exchange circulation pipeline. The drive motor 6 rotates the mixer around its own axis, stirring the ice cream base in the freezing cylinder 3, bringing it closer to the inner wall of the freezing cylinder 3 for heat exchange, thereby cooling and solidifying it into ice cream. The control panel 7 is used to control the compressor 4 and drive motor 6, regulating the refrigeration temperature by controlling the startup or shutdown of the compressor 4. Additionally, it controls the stirring action and speed of the mixer by controlling the startup or shutdown of the drive motor 6.

In a specific embodiment of the present application, a fixed casing 31 is provided on the outer side of the freezing cylinder 3. The freezing cylinder 3 is fixed to a horizontal plate 22 through the fixed casing 31.

Specifically, the stand 2 comprises a front support frame 21, a horizontal plate 22, a first support plate 23, and a second support plate 24.

The upper end of the front support frame 21 is detachably connected to the front end of the horizontal plate 22, and the lower end of the front support frame 21 is detachably connected to the bottom of the accommodating chamber 10. The upper end of the first support plate 23 is detachably connected to the rear end of the horizontal plate 22, and the lower end of the first support plate 23 is detachably connected to the bottom of the accommodating chamber 10. The lower end of the second support plate 24 is connected to the top surface of the horizontal plate 22, and the upper end of the second support plate 24 is detachably connected to the top of the accommodating chamber 10.

The first support plate 23 and the casing 1 cooperate to form a first containment chamber, where the heat exchanger 5 is located. The second support plate 24 and the casing 1 cooperate to form a second containment chamber, where the control panel 7 is located.

The upper end of the second support plate 24 is equipped with support plate fixing screw holes, and through the cooperation of screws and these screw holes, the upper end of the second support plate 24 is screw-connected to the casing 1, achieving fixation.

Adopting the above structure optimizes the assembly layout of the stand 2 while reducing the number of supports, reasonably utilizing space, and making the installation positions of components such as the freezing cylinder 3, compressor 4, heat exchanger 5, mixer, drive motor 6, and control panel 7 more compact. This results in a reduced volume for the cold drink dispenser, achieving miniaturization and adapting it to smaller spaces such as home kitchens.

Specifically, the horizontal plate 22 is concave downwardly to form an installation recess 220, and the bottom of the installation recess 220 is provided with an inclined surface that inclines toward one side in the length direction of the casing 1. The fixed end of the drive motor 6 abuts against the inclined surface, causing the drive motor 6 to incline toward one side in the length direction of the casing 1.

Adopting the above structure reasonably utilizes space by installing the drive motor 6 at an angle. When using a drive motor 6 of the same length, it reduces the vertical space required for installing the drive motor 6, eliminating the need to reserve excessive height for accommodating the drive motor 6. This decreases the overall height of the casing, further achieving miniaturization of the cold drink dispenser.

Preferably, the heat exchanger 5 is vertically installed in the first containment chamber; and the first support plate 23 is provided with a through hole, with a fan 231 located on the side of the through hole closer to the compressor 4.

The heat exchanger 5 can be referenced from existing radiators, consisting of a cover and multiple heat exchange tubes. When installed vertically, the multiple heat exchange tubes are installed vertically on the cover, with adjacent heat exchange tubes connected by elbows to form multiple S-shaped heat dissipation pipes.

The fan 231 aids in heat dissipation by rotating its blades to drive airflow, drawing air around the compressor 4 and generating airflow that passes through the heat exchanger 5 before being expelled outside the casing. This allows the heat naturally transferred from the compressor 4 to the surrounding air to be quickly carried away by the wind, improving the efficiency of heat removal by airflow and enhancing the heat dissipation effect of the compressor 4.

Adopting the above structure improves the space utilization rate of the accommodating chamber 10, reducing the width of the casing and the overall dimensions of the cold drink dispenser, further minimizing the occupied countertop area.

Furthermore, the rear side wall of the casing 1 is provided with a first louvered ventilation window 11 and a second louvered ventilation window 12. The position of the first louvered ventilation window 11 is compatible with the position of the first containment chamber, and the position of the second louvered ventilation window 12 is compatible with the position of the second containment chamber.

The position of the first louvered ventilation window 11 corresponds to the position of the first containment chamber, and the position of the second louvered ventilation window 12 corresponds to the position of the second containment chamber. They serve to assist in heat dissipation, preventing heat generated by the heat exchanger 5 and control panel 7 from accumulating within the accommodating chamber 10.

Furthermore, multiple heat dissipation holes 13 are spaced apart on both the left and right sides of the casing 1.

The heat dissipation holes 13 also aid in heat dissipation. The direction of rotation of the fan 231 can be set to allow air to enter through the first and second louvered ventilation windows 11 and 12, and exit through the heat dissipation holes 13, or alternatively, air can enter through the heat dissipation holes 13 and exit through the first and second louvered ventilation windows 11 and 12.

Specifically, the top surface of the casing 1 is equipped with a raw material inlet 14, which is connected to the feed end of the freezing cylinder 3. The front side wall of the casing 1 is provided with an ice cream outlet 15, which is connected to the discharge end of the freezing cylinder 3.

Adopting the above structure allows users to inject ice cream raw material through the raw material inlet 14 and dispense ice cream from the ice cream outlet 15. This utilizes the space on the top of the casing 1 as the feed inlet, eliminating the need to separately install a feed device on the side wall of the casing 1, thereby reducing the width or length of the casing 1 and shrinking the overall dimensions of the cold drink dispenser.

Specifically, the compressor 4 is installed vertically, making the centerline of its cylinder perpendicular to the bottom of the casing 1.

Adopting the above structure aligns the centerline of the compressor 4's cylinder with the ground, improving the space utilization rate of the accommodating chamber 10. This reduces the width of the casing and shrinks the overall dimensions of the cold drink dispenser, further minimizing the occupied countertop area.

Optionally, the left side wall and/or the right side wall of the casing 1 is provided with a recessed cavity 16 and an ice cream holder 17. One end of the ice cream holder 17 is hinged to the recessed cavity 16, and the size and shape of the recessed cavity 16 are compatible with the ice cream holder 17.

The recessed cavity 16 is used to accommodate the ice cream holder 17. One end of the ice cream holder 17 is hinged to the recessed cavity 16. When the ice cream holder 17 is not needed, it can be directly stored within the recessed cavity 16. When the ice cream holder 17 is required to hold prepared ice creams or cones, it can be pulled out from the recessed cavity 16 and its one end made to tightly abut against the lower wall of the recessed cavity 16, allowing the prepared ice creams or cones to be placed in the through-holes of the ice cream holder 17. Adopting this structure rationalizes space utilization and avoids occupying space when the ice cream holder 17 is not in use.

Specifically, the control panel 7 and/or the heat exchanger 5 are located at the edge of the bracket 2 and closely positioned against the casing 1. Adopting this structure facilitates heat dissipation.

Specifically, the cold drink dispenser is an ice cream machine or a slushie machine. Depending on the composition or water content of the input ice cream raw material, the cold drink dispenser can prepare ice cream or slushies.

The technical principles of this application have been described above in conjunction with specific embodiments. These descriptions are intended solely to explain the principles of this application and should not be interpreted in any way as limiting the scope of protection of this application. Based on this explanation, technicians in the field can readily envision other specific implementations of this application without requiring inventive effort, and these equivalent variations or substitutions are encompassed within the scope defined by the claims of this application.

What is claimed is:

1. A compact cold drink dispenser, comprising a casing, a bracket, a freezing cylinder, a compressor, a heat exchanger, a mixer, a drive motor, and a control panel;
wherein the casing is provided with a containment cavity, the bracket is disposed within the containment cavity, and the bracket divides the containment cavity into a mixing and preparation layer and a heat exchange and refrigeration layer; the mixer is installed inside the freezing cylinder, and the drive motor drives the mixer to rotate; the freezing cylinder, the drive motor, and the control panel are disposed in the mixing and preparation layer; the compressor and the heat exchanger are detachably connected to the heat exchange and refrigeration layer; the control panel is electrically connected to both the drive motor and the compressor;
wherein the compressor and the heat exchanger are connected through a heat exchange circulation pipeline, and the compressor is provided with a refrigeration circulation pipeline, which passes through the bracket and is wound around the periphery of the freezing cylinder; one end of the refrigeration circulation pipeline is connected to the cold source output end of the compressor, and the other end of the refrigeration circulation pipeline is connected to the heat source input end of the compressor.

2. The compact cold drink dispenser according to claim 1, wherein the bracket comprises a front support frame, a horizontal plate, a first support plate, and a second support plate;
wherein the upper end of the front support frame is detachably connected to the front end of the horizontal plate, and the lower end of the front support frame is detachably connected to the bottom of the accommodation cavity; the upper end of the first support plate is detachably connected to the rear end of the horizontal plate, and the lower end of the first support plate is detachably connected to the bottom of the accommodation cavity; the lower end of the second support plate is connected to the top surface of the horizontal plate; the upper end of the second support plate is detachably connected to the top of the accommodation cavity;
wherein the first support plate and the casing cooperate to form a first accommodation chamber with the heat exchanger disposed therein; the second support plate and the casing cooperate to form a second accommodation chamber with the control panel disposed therein.

3. The compact cold drink dispenser according to claim 2, wherein the horizontal plate is recessed downward to form an installation recess, the bottom of the installation recess is provided with an inclined surface inclined towards one side of the casing in the length direction, and the fixed end of the drive motor abuts against the inclined surface, causing the drive motor to be inclined towards one side of the casing in the length direction.

4. The compact cold drink dispenser according to claim 2, wherein the heat exchanger is vertically installed in the first accommodation chamber; and the first support plate is provided with a through hole, and a fan is disposed on one side of the through hole close to the compressor.

5. The compact cold drink dispenser according to claim 2, wherein the rear side wall of the casing is provided with a first louvered heat dissipation window and a second louvered heat dissipation window, the positions of the first and second louvered heat dissipation windows being compatible with the position of the first and second accommodation chambers, respectively.

6. The compact cold drink dispenser according to claim 1, wherein the top surface of the casing is provided with a raw material inlet connected to the feeding end of the freezing cylinder, and the front side wall of the casing is provided with an ice cream outlet connected to the discharging end of the freezing cylinder.

7. The compact cold drink dispenser according to claim 1, wherein the compressor is vertically installed, so that the cylinder centerline of the compressor is perpendicular to the bottom of the casing.

8. The compact cold drink dispenser according to claim 1, wherein the left side wall and/or right side wall of the casing is provided with a recessed cavity and an ice cream holder, one end of the ice cream holder being hinged to the recessed cavity, the size and shape of the recessed cavity being compatible with the ice cream holder.

9. The compact cold drink dispenser according to claim 1, wherein the control panel and/or the heat exchanger are located at the edge of the bracket and closely adjacent to the casing.

10. The compact cold drink dispenser according to claim 1, wherein the cold drink dispenser is an ice cream machine or a slushie machine.
